(19) United States
(12) Patent Application Publication
(10) Pub. No.: US 2016/0226116 A1
(43) Pub. Date: Aug. 4, 2016

(54) BATTERY PACK

(71) Applicant: SAMSUNG SDI CO., LTD., Yongin-si (KR)

(72) Inventors: Kyounghwan NOH, Yongin-si (KR); Jongseop KWAK, Yongin-si (KR); Sanggyu KIM, Yongin-si (KR); Shangchul SEOK, Yongin-si (KR)

(21) Appl. No.: 15/001,273

(22) Filed: Jan. 20, 2016

(30) Foreign Application Priority Data
Jan. 30, 2015 (KR) 10-2015-0015591

(51) Int. Cl. H01M 10/6557; H01M 10/613; H01M 2/10

(52) U.S. Cl. CPC H01M 10/6557; H01M 2/1077; H01M 2/1022; H01M 10/613

(57) ABSTRACT

A battery pack, including a plurality of battery cells; and first spacers and second spacers between the plurality of battery cells to form gap flow paths, the first spacers and second spacers extending to face each other, the first spacers extending from a first position and the second spacers extending from a second position, the first and second positions facing each other such that the first and second spacers interlock.

### CROSS-REFERENCE TO RELATED APPLICATION

Korean Patent Application No. 10-2015-0015591, filed on Jan. 30, 2015, in the Korean Intellectual Property Office, and entitled “Battery Pack,” is incorporated by reference herein in its entirety.

### BACKGROUND

1. Field

One or more exemplary embodiments relate to a battery pack.

2. Description of the Related Art

Secondary batteries may be rechargeable unlike primary batteries that cannot be recharged. The secondary batteries may be used as energy sources in, for example, mobile devices, electric vehicles, hybrid vehicles, electric bicycles, and uninterruptible power supplies, and may be of a single-battery type or a pack type in which multiple batteries may be electrically connected to each other and bound in one unit, according to types of external devices using the secondary batteries.

### SUMMARY

Embodiments may be realized by providing a battery pack, including a plurality of battery cells; and first spacers and second spacers between the plurality of battery cells to form gap flow paths, the first spacers and second spacers extending to face each other, the first spacers extending from a first position and the second spacers extending from a second position, the first and second positions facing each other such that the first and second spacers interlock.

The first spacers and second spacers may extend at least to locations where end portions of the first spacers overlap end portions of the second spacers.

End portions of the first spacers may extend toward the second position, but may not reach the second position.

End portions of the second spacers may extend toward the first position, but may not reach the first position.

Each of the first spacers and the second spacers may include a plurality of unit members between neighboring battery cells.

Each of the plurality of unit members may have a pole shape extending in one direction.

The first position may correspond to a first case, the second position may correspond to a second case, and the first and second cases may be coupled to each other along upward and downward directions, in which the first spacers and second spacers face each other, by interposing the plurality of battery cells between the first and second cases.

The first spacers may extend from the first case to the second case, and end portions of the first spacers may be separated from the second case, and the second spacers may extend from the second case to the first case, and end portions of the second spacers may be separated from the first case.

The gap flow paths may include a space between the first spacers and the second case, a space between the first and second spacers interlocking with one another in a comb form, and a space between the second spacers and the first case.

The gap flow paths may induce air flow in a zigzag pattern reciprocating along the upward and downward directions.

The battery cells may include battery cells aligned in a first column and a second column, and a main flow path connected to a fluid machine may be formed between the battery cells in the first column and the battery cells in the second column.

The battery cells in the first column and the battery cells in the second column may be aligned diagonally with respect to the main flow path.

The battery cells in the first column and the battery cells in the second column may be symmetrically aligned with respect to the main flow path.

The battery pack may further include a first case and a second case coupled to each other in upward and downward directions, the first spacers and second spacers facing each other in the upward and downward directions, the first and second cases providing a space for housing the battery cells. The first case may have a box shape including a bottom portion, side portions for forming the space, and an open upper portion, and the second case may have a plate shape that covers the open upper portion of the first case.

The main flow path may be formed in a front-rear direction of the first case, the battery cells in the first column and the battery cells in the second column may be aligned on left and right sides of the main flow path, one of the side portions may be on a front of the first case, the one side portion may include a first through hole, and side portions on left and right sides of the first case may each include a second through hole.

The first through hole may be connected to the fluid machine and may discharge air to outside the battery pack, and the second through holes may receive air from outside the battery pack.

The fluid machine may generate air flow by using a suction force.

### BRIEF DESCRIPTION OF THE DRAWINGS

Features will become apparent to those of skill in the art by describing in detail exemplary embodiments with reference to the attached drawings in which:

FIG. 1 illustrates a perspective view of a battery pack according to an exemplary embodiment;

FIG. 2 illustrates an exploded perspective view of the battery pack of FIG. 1;

FIG. 3 illustrates a plan structure of a first case of FIG. 1;

FIG. 4 schematically illustrates air flow in the battery pack of FIG. 1; and

FIG. 5 illustrates a cross-sectional view taken along a line V-V of FIG. 2 (not indicated in FIG. 2) and schematically illustrates air flow in neighboring battery cells.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

Hereinafter, a battery pack will be described in detail by explaining exemplary embodiments with reference to the attached drawings.

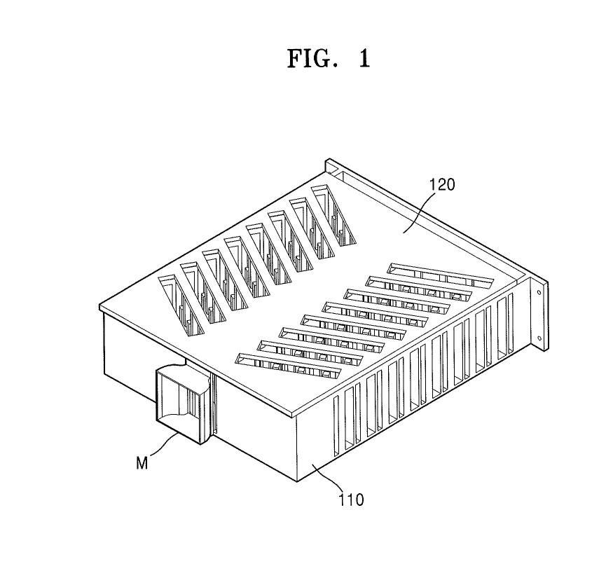

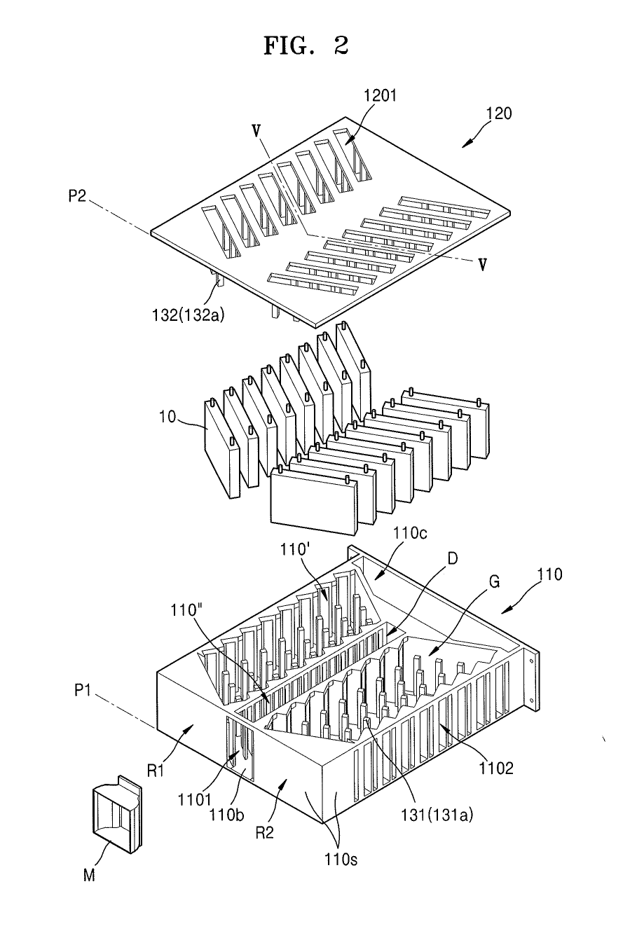

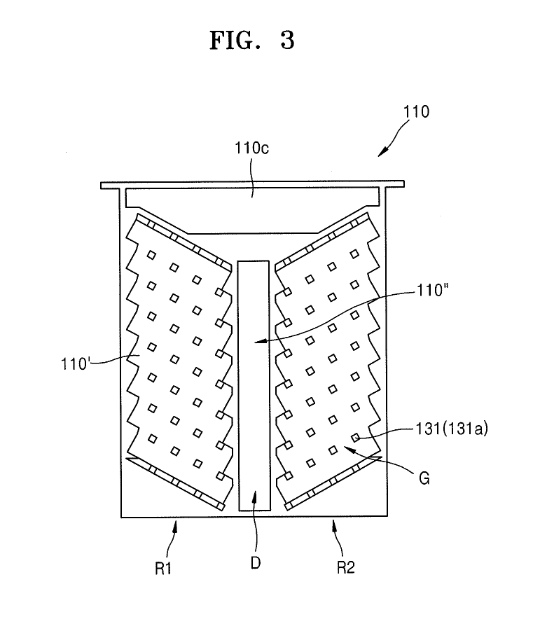

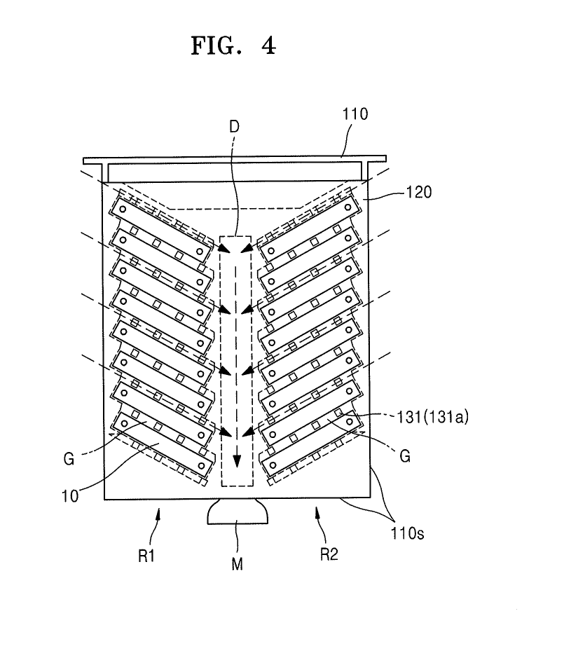

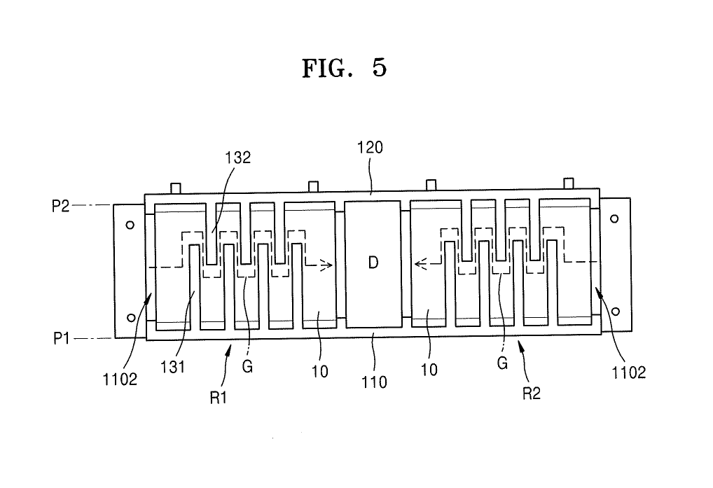

FIG. 1 illustrates a perspective view of a battery pack according to an exemplary embodiment. FIG. 2 illustrates an exploded perspective view of the battery pack of FIG. 1. FIG. 3 illustrates a plan structure of a first case 110 of FIG. 1. FIG. 4 schematically illustrates air flow in the battery pack of FIG. 1. Also, FIG. 5 illustrates a cross-sectional view taken along a line V-V of FIG. 2 (not indicated in FIG. 2) and schematically illustrates air flow in neighboring battery cells. For convenience of illustration, the battery cells are not illustrated in FIG. 1.

Referring to the attached drawings, the battery pack may include at least two battery cells 10 and spacers 131 and 132 aligned between the battery cells 10. The spacers 131 and 132 may induce air flow in a reciprocating zigzag pattern between the neighboring battery cells 10.

The battery cells 10 may be aligned in a first column R1 and a second column R2. The battery cells 10 in the first column R1 and the battery cells in the second column R2 may be aligned in a diagonal direction, e.g., at an acute angle, based on a main flow path D formed at the center of the battery pack. For example, the battery cells 10 in the first column R1 and the battery cells 10 in the second column R2 may be diagonally aligned at an acute angle to the main flow path D. The battery cells 10 in the first column R1 and the battery cells in the second column R2 may be symmetrically aligned with respect to the main flow path D.

The spacers 131 and 132 may be aligned between the neighboring battery cells 10. The spacers 131 and 132 may include first spacers 131 and second spacers 132 protruding in an upward direction and a downward direction of the battery pack in which the first spacers and second spacers face each other. For example, the first spacers 131 may extend in the upward direction from a first position P1 (corresponding to a bottom position), and the second spacers 132 may extend in the downward direction from a second position P2 (corresponding to a top position). The first and second spacers 131 and 132 may interlock with one another in a comb form and may be alternately formed.

The first and second spacers 131 and 132 may extend from the first position P1 and the second position P2, and the first position P1 and the second position P2 may respectively correspond to the first case 110 and a second case 120, which may be coupled to each other in the upward direction and downward direction in which the first spacers and second spacers face each other. The first and second spacers 131 and 132 may be respectively formed in the first case 110 and the second case 120. The first spacers 131 may protrude in the upward direction toward the second case 120 from the first case 110, and the second spacers 132 may protrude in the downward direction toward the first case 110 from the second case 120.

The first spacers 131 may include a plurality of unit members 131a aligned between a pair of neighboring battery cells 10 in a diagonal direction. Similarly, the second spacers 132 may include a plurality of unit members 132a aligned between a pair of neighboring battery cells 10 in a diagonal direction. The unit members 131a and 132a of the first and second spacers 131 and 132 may have substantially the same pole shape. The phrase “pole shape” refers to an elongated shape extending in one direction (a vertical direction), and a cross-section of the pole shape may have various shapes such as a circular, oval, rectangular, or polygonal shape.

The first and second spacers 131 and 132 may interlock with one another in a comb form. Gap flow paths G may be formed between the first and second spacers 131 and 132, which may interlock with one another. As shown in FIG. 5, the gap flow paths G may be formed in a zigzag pattern reciprocating along the upward and downward directions.

Referring to the attached drawings, the first spacers 131 may extend toward the second case 120, which may be disposed at a top portion of the battery pack, from the first case 110, and may not contact the second case 120 (for example, the first spacers 131 may extend toward the second position P2, and may not reach the second position P2). Similarly, the second spacers 132 may extend toward the first case 110, which may be disposed at a bottom portion of the battery pack, from the second case 120, and may not contact the first case 110 (for example, the second spacers 132 may extend toward the first position P1, and may not reach the first position P1).

The first spacers 131 may extend in the upward direction from the first case 110, and end portions of the first spacers 131 may be not contact the second face 120 and may be separated from the second case 120. The second spacers 132 may extend in the downward direction from the second case 120, and end portions of the second spacers 132 may not contact the first case 110 and may be separated from the first case 110. The end portions of the first spacers 131 and the end portions of the second spacers 132 may form the gap flow paths G between the second case 120 and the first case 110, which respectively may face the end portions of the first spacers 131 and the end portions of the second spacers 132.

The first and second spacers 131 and 132 may extend in the upward and downward directions, in which the first spacers and second spacers face each other, to locations where the end portions of the first spacers 131 overlap the end portions of the second spacers 132. The first and second spacers 131 and 132 may extend to the locations where the end portions of the first spacers 131 overlap the end portions of the second spacers 132 or may extend further from the locations where the end portions of the first spacers 131 overlap the end portions of the second spacers 132. As described below, this structure may generate flow reciprocating in a zigzag pattern along the upward and downward directions, for example, due to the first and second spacers 131 and 132, and may be configured to block the shortest flow path that passes straight between the first and second spacers 131 and 132 and increase the length of a heat dissipation path by forming a flow path reciprocating in a zigzag pattern.

In short, it may be advantageous that the first and second spacers 131 and 132 extend in the upward and downward directions, in which the first spacers and second spacers face each other, and overlap one another, and do not contact the second case 120 and the first case 110, which respectively face the end portions of the first spacers 131 and the end portions of the second spacers 132.

The gap flow paths G may be defined by the first and second spacers 131 and 132, which may interlock with each other, and may have a zigzag pattern reciprocating along the upward and downward directions. The gap flow paths G may be formed when a space between the first spacers 131 and the second case 120, a space between the first and second spacers 131 and 132, which may interlock with each other, and a space between the second spacers 132 and the first case 110 are continuously connected, e.g., the gap flow paths may include a space between the first spacers and the second case, a space between the first and second spacers interlocking with one another in a comb form, and a space between the second spacers and the first case. As a space between the first spacers 131 and the second case 120, a space between the first and second spacers 131 and 132, and a space between the second spacers 132 and the first case 110 are interconnected, the gap flow paths G may have a reciprocating zigzag pattern.

As shown in FIG. 4, air that forcibly flows, for example, due to a fluid machine M, may pass through the gap flow paths G, and the battery cells 10 may dissipate heat. In one exemplary embodiment, the fluid machine M may be of a suction type which generates air flow through a suction force providing negative pressure. In an embodiment, the fluid machine M may be of a blow type which forces air flow by providing positive pressure.

A pressure difference generated by the fluid machine M may generate air flow in the main flow path D and may generate air flow in the gap flow paths G continuously connected to the main flow path D. For example, the fluid machine M may be formed on the main flow path D. The main flow path D may be formed along a front-rear direction of the battery pack, and the fluid machine M may be arranged on a front side of the first case 110. The pressure difference generated by the fluid machine M may absorb air flow through the main flow path D and may generate air flow of the gap flow paths G continuously connected to the main flow path D. The air flow through the gap flow paths G may have a zigzag pattern reciprocating along the upward and downward directions, for example, due to the first and second spacers 131 and 132, which may interlock with one another in a comb form. As the air flow through the gap flow paths G has the zigzag pattern reciprocating along the upward and downward directions, lengths of the gap flow paths G exchanging heat with the battery cells 10 may be doubled. If the gap flow paths G are not formed in the zigzag pattern and have the shortest distance by crossing the battery cells 10, the lengths of the gap flow paths G may not be great enough to exchange heat with the battery cells 10.

Referring to FIG. 4, the battery cells 10 in the first and second columns R1 and R2 may be diagonally aligned at a predetermined acute angle to the main flow path D by interposing the main flow path D therebetween. According to operations of the fluid machine M formed on the main flow path D, air flow may be generated in the main flow path D and in the gap flow paths G continuously connected to the main flow path D. As the battery cells 10 in the first and second columns R1 and R2 are diagonally aligned at a predetermined acute angle to the main flow path D, the fluid resistance between the main flow path D and the gap flow paths G may decrease, and pressure loss may also decrease, and the operation power of the fluid machine M for generating the same amount of flux may decrease.

In one exemplary embodiment, the battery cells 10 may be aligned in the first and second columns R1 and R2. In an exemplary embodiment, the battery cells 10 may be aligned in a single column on any one of a left or right side of the main flow path D, or may be aligned in four columns on both the left and right sides of the main flow path D.

In one exemplary embodiment, the battery cells 10 may be diagonally aligned with respect to the main flow path D. In an exemplary embodiment, the battery cells 10 may be vertically aligned with respect to the main flow path D. According to the exemplary embodiment described with reference to FIG. 4, if the gap flow paths G between the battery cells 10 are diagonally formed with respect to the main flow path D, the gap flow paths G between the battery cells 10 may be vertically aligned with respect to the main flow path D. The first and second spacers 131 and 132, which may be disposed between a pair of neighboring battery cells 10, may interlock with one another in a comb form and may induce air circulating in a zigzag pattern reciprocating along the upward and downward directions.

Referring to FIG. 2, the battery pack may include the battery cells 10 disposed between the first case 110 and the second case 120, and the first case 110 and the second case 120 coupled in the upward and downward directions, in which the first spacers and second spacers face each other. The first and second spacers 131 and 132 may be respectively formed in the first case 110 and the second case 120.

The first case 110 and the second case 120 may have a space for housing the battery cells 10. The first case 110 and the second case 120 may be asymmetrically formed. The first case 110 may include a bottom portion 110b and side portions 110s to form a housing space, and the second case 120 disposed on the first case 110 may form a ceiling of the housing space. The first case 110 may have a hexahedron-box shape having an open upper portion, and the second case 120 may have a flat-panel shape. The second case 120 may be disposed on the first case 110 to cover the open upper portion of the first case 110.

An opening 110′ may be formed in the upper portion of the first case 110 to insert the battery cells 10 into the first case 110, and the second case 120 may be assembled on the battery cells 10, which may be housed in the first case 110, through the opening 110′. Therefore, the open upper portion of the first case 110 may not mean that the first case 110 does not have an upper structure, but may mean that the opening 110′ for assembling the battery cells 10 may be formed.

In the first case 110, an opening 110″ corresponding to the main flow path D may be formed. The opening 110″ may be covered by the second case 20. The openings 110′ and 110″ may be provided for convenience of assembly of the battery cells 10 and the fluid machine M. The first case 110 may have a circuit housing portion 110c for housing a protection circuit module. The second case 120 may be disposed on the circuit housing portion 110c, in which the protection circuit module may be housed.

At least one of the first case 110 and the second case 120 may have through holes, for example, first and second through holes 1101 and 1102 for inducing low-temperature air and discharging heated air. For example, the first through hole 1101 and the second through hole 1102 may be formed in the side portions 110s of the first case 110. The first through hole 1101 may be formed to be adjacent to the fluid machine M to be connected to the main flow path D. The first through hole 1101 may be fluidally connected to the fluid machine M. For example, the fluid machine M may be mounted in the first through hole 1101, and the first through hole 1101 may forcibly discharge inner air to the outside, for example, due to a pressure difference generated by the fluid machine M. The second through hole 1102 may be formed to be adjacent to the battery cells 10 to be connected to the gap flow paths G.

In one exemplary embodiment, the fluid machine M may be of a suction type which may generate air flow through a suction force. The low-temperature air coming through the second through hole 1102 may be heated when passing through the gap flow paths G between the battery cells 10 and may be discharged to the outside by sequentially passing through the main flow path D and the first through hole 1101. The second through hole 1102 may function as an inlet for receiving the low-temperature air, and the first through hole 1101 may function as an outlet for discharging the heated air.

For example, when the main flow path D is formed along a front-rear direction of the battery pack, the first through hole 1101 may be formed in the side portion 110s on the front of the battery pack, and when the battery cells 10 in the first and second columns R1 and R2 are aligned on the left and right sides of the battery pack, the second through hole 1102 may be formed in the side portions 110s on the left and right sides of the battery pack.

Openings 1201 may be formed in the second case 1120 to expose upper portions of the battery cells 10. For example, the openings 1201 of the second case 120 may be formed in a diagonal direction such that the openings 1201 may be parallel to the battery cells 10 at locations corresponding to the battery cells 10. For example, a bus bar for electrically connecting the battery cells 10 or wires for obtaining or transmitting state information of the battery cells 10 may be arranged on the upper portions of the battery cells 10 which may be exposed by the openings 1201 and may be connected to terminals formed on the upper portions of the battery cells 10.

The openings 1201 formed in the second case 120 may function as outlets for discharging the heated air to the outside. For example, flow of the air, which may be heated while passing through the gap flow paths G between the battery cells 10, may be elevated, for example, due to buoyancy, and the air may be discharged to the outside via the openings 1201 of the second case 120.

According to one or more exemplary embodiments, a battery pack that may have improved heat dissipation efficiency is provided. As heat dissipation paths having a zigzag pattern reciprocating between the neighboring battery cells 10 may be formed, heat dissipation paths having enough lengths may be formed. As the air flowing in the heat dissipation paths and heat in the battery cells 10 are sufficiently exchanged, the heat dissipation efficiency of the battery cells 10 may be improved.

As the battery cells 10 may be aligned in a diagonal direction with respect to the main flow path D connected to a fluid machine M, pressure loss between the main flow path D and the gap flow paths G disposed between the battery cells 10 may decrease, and operation, e.g., driving, power of the fluid machine M for generating air flow having the same flux may be decreased.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a plurality of battery cells; and
first spacers and second spacers between the plurality of battery cells to form gap flow paths, the first spacers and second spacers extending to face each other, the first spacers extending from a first position and the second spacers extending from a second position, the first and second positions facing each other such that the first and second spacers interlock.

2. The battery pack as claimed in claim 1, wherein the first spacers and second spacers extend at least to locations where end portions of the first spacers overlap end portions of the second spacers.

3. The battery pack as claimed in claim 1, wherein end portions of the first spacers extend toward the second position, but do not reach the second position.

4. The battery pack as claimed in claim 1, wherein end portions of the second spacers extend toward the first position, but do not reach the first position.

5. The battery pack as claimed in claim 1, wherein each of the first spacers and the second spacers include a plurality of unit members between neighboring battery cells.

6. The battery pack as claimed in claim 5, wherein each of the plurality of unit members has a pole shape extending in one direction.

7. The battery pack as claimed in claim 1, wherein:
the first position corresponds to a first case,
the second position corresponds to a second case, and
the first and second cases are coupled to each other along upward and downward directions, in which the first spacers and second spacers face each other, by interposing the plurality of battery cells between the first and second cases.

8. The battery pack as claimed in claim 7, wherein:
the first spacers extend from the first case to the second case, and end portions of the first spacers are separated from the second case, and
the second spacers extend from the second case to the first case, and end portions of the second spacers are separated from the first case.

9. The battery pack as claimed in claim 8, wherein the gap flow paths includes a space between the first spacers and the second case, a space between the first and second spacers interlocking with one another in a comb form, and a space between the second spacers and the first case.

10. The battery pack as claimed in claim 9, wherein the gap flow paths induce air flow in a zigzag pattern reciprocating along the upward and downward directions.

11. The battery pack as claimed in claim 1, wherein:
the battery cells include battery cells aligned in a first column and a second column, and
a main flow path connected to a fluid machine is formed between the battery cells in the first column and the battery cells in the second column.

12. The battery pack as claimed in claim 11, wherein the battery cells in the first column and the battery cells in the second column are aligned diagonally with respect to the main flow path.

13. The battery pack as claimed in claim 12, wherein the battery cells in the first column and the battery cells in the second column are symmetrically aligned with respect to the main flow path.

14. The battery pack as claimed in claim 11, further comprising a first case and a second case coupled to each other in upward and downward directions, the first spacers and second spacers facing each other in the upward and downward directions, the first and second cases providing a space for housing the battery cells,
wherein:
the first case has a box shape including a bottom portion, side portions for forming the space, and an open upper portion, and
the second case has a plate shape that covers the open upper portion of the first case.

15. The battery pack as claimed in claim 14, wherein:
the main flow path is formed in a front-rear direction of the first case,
the battery cells in the first column and the battery cells in the second column are aligned on left and right sides of the main flow path,
one of the side portions being on a front of the first case, the one side portion includes a first through hole, and
side portions on left and right sides of the first case each include a second through hole.

16. The battery pack as claimed in claim 15, wherein:
the first through hole is connected to the fluid machine and discharges air to outside the battery pack, and
the second through holes receives air from outside the battery pack.

17. The battery pack as claimed in claim 16, wherein the fluid machine generates air flow by using a suction force.
